(19) United States
(12) Patent Application Publication
(10) Pub. No.: US 2020/0150630 A1
(43) Pub. Date: May 14, 2020

(54) METHOD FOR ADJUSTING FREQUENCY RESPONSE PARAMETER OF MACHINE TOOL AND SYSTEM USING THE SAME

(71) Applicant: INDUSTRIAL TECHNOLOGY RESEARCH INSTITUTE, Hsinchu (TW)

(72) Inventors: Chen-Hui KUO, Taichung City (TW); Chen-Yu KAI, Ligang Township (TW); Ta-Jen PENG, Taichung City (TW); Yung-Chih LIN, Taichung City (TW)

(73) Assignee: INDUSTRIAL TECHNOLOGY RESEARCH INSTITUTE, Hsinchu (TW)

(21) Appl. No.: 16/232,424

(22) Filed: Dec. 26, 2018

(30) Foreign Application Priority Data
Nov. 14, 2018 (TW) 107140434

(51) Int. Cl. G05B 19/4155

(52) U.S. Cl. CPC G05B 19/4155; G05B 2219/31103

(57) ABSTRACT

A method for adjusting a frequency response parameter of a machine tool and a system using the same are provided. The method includes the following steps. Firstly, an actual frequency sweep is performed on the machine tool to acquire an original system closed loop data of the machine tool. Then, an original system open loop transfer function of the original system closed loop data is acquired. Then, a speed optimization procedure is executed to determine an optimized speed parameter. Then, a speed optimized open loop transfer function corresponding to a speed optimized close loop transfer function is acquired. Then, a filter transfer function of a filter is determined. Then, a filter optimization procedure is executed.

This application claims the benefit of Taiwan application Serial No. 107140434, filed Nov. 14, 2018, the disclosure of which is incorporated by reference herein in its entirety.

### TECHNICAL FIELD

This disclosure relates to a method for adjusting a frequency response parameter of a machine tool and a system using the same, and more particularly to an optimized method for adjusting a frequency response parameter of a machine tool and a system using the same.

### BACKGROUND

Generally speaking, real machine adjustments of controller parameters of machine tools are performed by ways of trial and error before being shipped out. However, such the adjustment method is very time-consuming. Therefore, it is one of the directions of the industry's efforts in this technical field to propose a new method for controller parameters to improve the above-mentioned problems.

### SUMMARY

According to one embodiment of this disclosure, a method for adjusting a frequency response parameter of a machine tool is provided. The method for adjusting the frequency response parameter of the machine tool includes the following steps. An actual frequency sweep is performed on a machine tool to acquire an original system closed loop data of the machine tool; an original system open loop transfer function of the original system closed loop data is acquired; a speed optimization procedure is executed to acquire a speed optimized close loop transfer function and an optimized speed parameter; a filter transfer function of a filter is determined; and a filter optimization procedure is executed to acquire an optimized filter transfer function.

According to another embodiment of this disclosure, a system for adjusting a frequency response parameter of a machine tool is provided. The system for adjusting the frequency response parameter of the machine tool includes a frequency sweeper, an open loop transfer function acquirer, a speed optimizer and a filter optimizer. The frequency sweeper performs an actual frequency sweep on a machine tool to acquire an original system closed loop data of the machine tool. The open loop transfer function acquirer acquires an original system open loop transfer function of the original system closed loop data. The speed optimizer executes a speed optimization procedure to acquire a speed optimized close loop transfer function and an optimized speed parameter. The speed optimization procedure includes: acquiring a speed optimized open loop transfer function corresponding to the speed optimized close loop transfer function; executing a filter optimization procedure to determine a filter transfer function of a filter and execute a filter optimization procedure to acquire an optimized filter transfer function.

The above and other aspects of this disclosure will become better understood with regard to the following detailed description of the preferred but non-limiting embodiments. The following description is made with reference to the accompanying drawings.

### BRIEF DESCRIPTION OF THE DRAWINGS

FIG. 1 is a functional block diagram showing a system for adjusting a frequency response parameter of a machine tool according to an embodiment of this disclosure.

FIGS. 2A to 2C are flow charts showing a method for adjusting a frequency response parameter of a machine tool according to an embodiment of this disclosure.

FIG. 2D is a block diagram showing a full control system of an adjustment method according to an embodiment of this disclosure.

FIG. 3 is a schematic view showing an original system closed loop data acquired after an actual frequency sweep is performed on the machine tool of FIG. 1.

FIG. 4 is a block diagram showing a close loop control system constituted by a middle open loop transfer function according to the embodiment of this disclosure.

FIG. 5 is a block diagram showing a control system constituted by a middle speed optimized open loop transfer function according to the embodiment of this disclosure.

FIG. 6 is a Bode plot showing a first filter transfer function of a first filter according to an embodiment of this disclosure.

FIG. 7A is a block diagram showing a control system constituted by the speed optimized open loop transfer function, the first filter transfer function and a second filter transfer function according to an embodiment of this disclosure.

FIG. 7B is a block diagram showing a control system constituted by the first filter transfer function and the speed optimized open loop transfer function according to an embodiment of this disclosure.

FIG. 8 is a system Bode plot acquired after speed optimization and filter optimization according to an embodiment of this disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

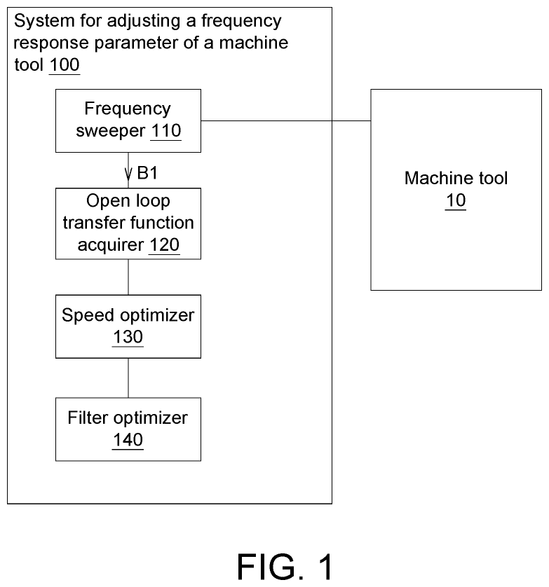

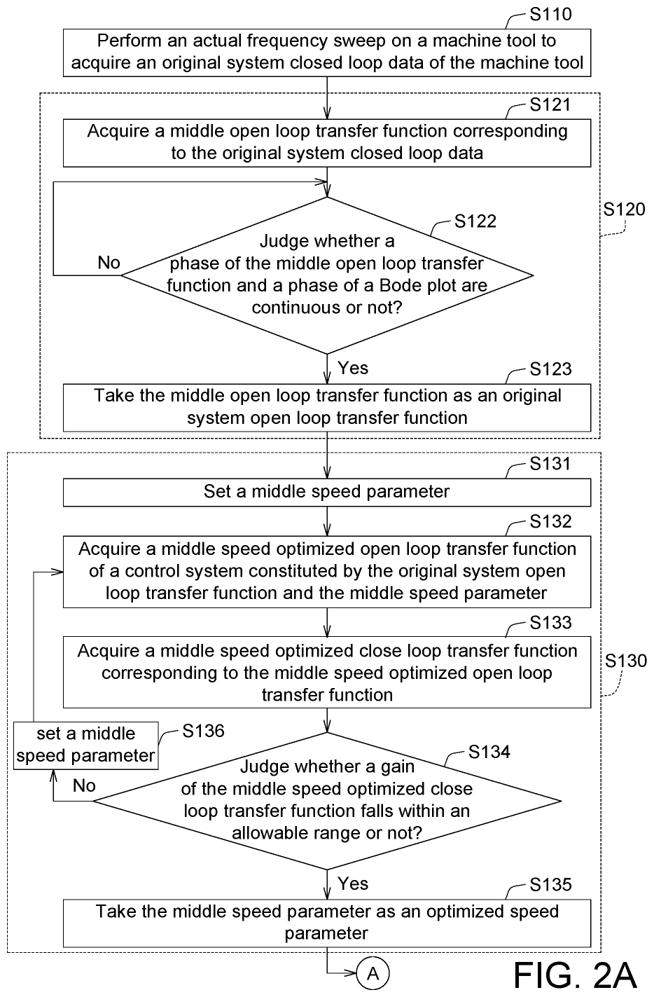

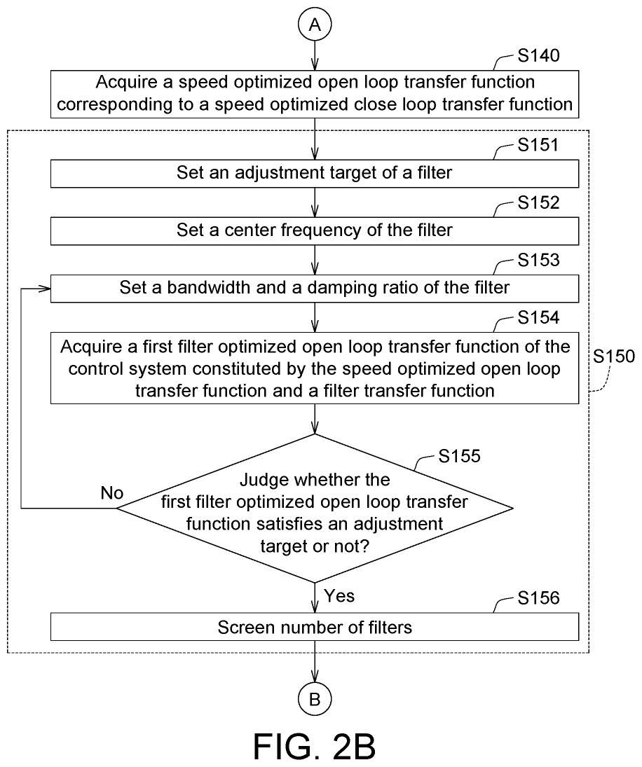

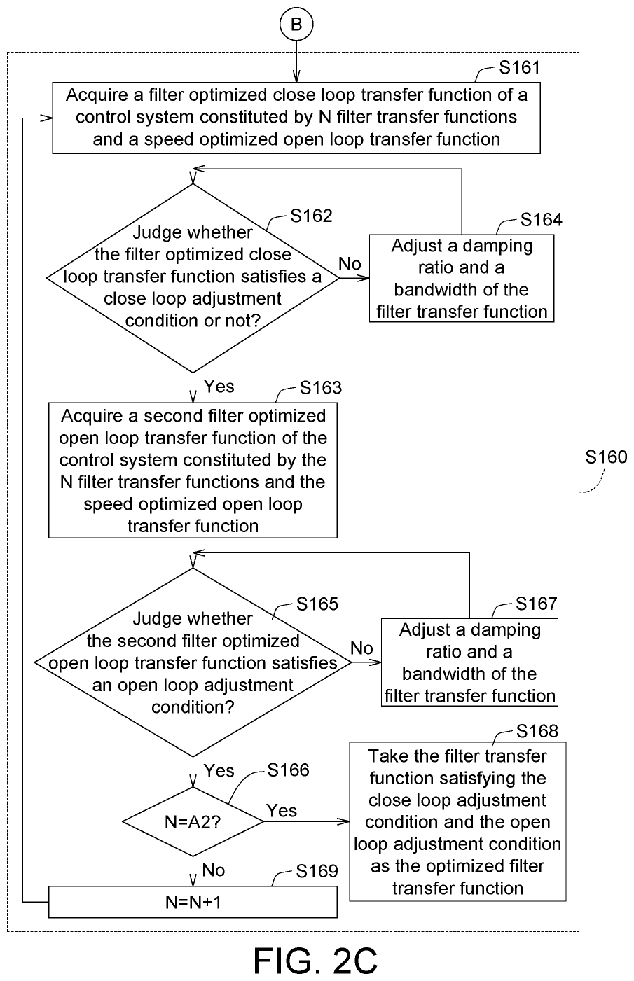

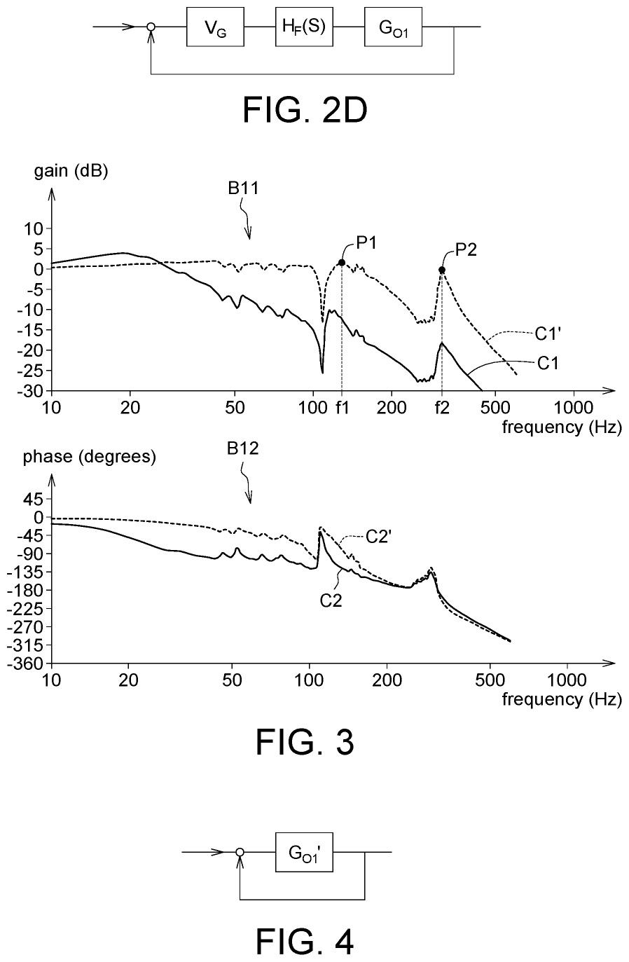

Please refer to FIGS. 1 and 2A to 2C. FIG. 1 is a functional block diagram showing a system 100 for adjusting a frequency response parameter of a machine tool according to an embodiment of this disclosure. FIGS. 2A to 2C are flow charts showing a method for adjusting a frequency response parameter of a machine tool according to an embodiment of this disclosure.

The system 100 for adjusting the frequency response parameter of the machine tool includes a frequency sweeper 110, an open loop transfer function acquirer 120, a speed optimizer 130 and a filter optimizer 140.

The frequency sweeper 110, the open loop transfer function acquirer 120, the speed optimizer 130 and/or the filter optimizer 140 may be circuit structures (circuits) formed by semiconductor processes. At least two of the frequency sweeper 110, the open loop transfer function acquirer 120, the speed optimizer 130 and the filter optimizer 140 may be integrated into a single component; at least one of the frequency sweeper 110, the open loop transfer function acquirer 120, the speed optimizer 130 and the filter optimizer 140 may be integrated into a processor or a controller; or a field programmable gate array (FPGA) and a digital signal processor are used to implement the system 100 for adjusting the frequency response parameter of the machine tool.

A flow of a method for adjusting a frequency response parameter of a machine tool is illustrated in FIGS. 2A to 2C hereinbelow. FIG. 2D is a block diagram showing a full control system of an adjustment method according to an embodiment of this disclosure. Referring to FIG. 2D, through the processes of FIGS. 2A to 2C, a speed parameter V_{G} and a filter transfer function H_{F}(s) in FIG. 2D can be adjusted to optimize a control system constituted by an original system open loop transfer function G_{O1}, the speed parameter V_{G} and the filter transfer function H_{F}(s) (shown in FIG. 2D). Examples will be described in the following.

FIG. 3 is a schematic view showing an original system closed loop data acquired after an actual frequency sweep is performed on a machine tool 10 of FIG. 1. In a step S110, as shown in FIG. 3, the frequency sweeper 110 performs the actual frequency sweep on the machine tool 10 to acquire the original system closed loop data B1 of the machine tool 10. As shown in FIG. 3, the original system closed loop data B1 may be, for example, drawn into the Bode plot data, wherein the Bode plot includes the gain Bode plot B11 and the phase Bode plot B12. In the gain Bode plot B11, a curve C1 is a frequency-versus-gain relationship curve before the speed optimization and the filter optimization, and a curve C1′ is a frequency-versus-gain relationship curve after the speed optimization. In the phase Bode plot B12, a curve C2 is a frequency-versus-phase relationship curve before the speed optimization and the filter optimization, and a curve C2′ is a frequency-versus-phase relationship curve after the speed optimization.

In a step S120, the open loop transfer function acquirer 120 may adopt the automatic control computing technology to acquire the original system open loop transfer function G_{O1} corresponding to the original system closed loop data B1, as shown in FIG. 2D.

There are many processes of acquiring the original system closed loop data B1 in the step S120, and one of the steps S121 to S123 is described in the following.

FIG. 4 is a block diagram showing a control system constituted by a middle open loop transfer function G_{O1′} according to the embodiment of this disclosure. In the step S121, as shown in FIG. 4, the open loop transfer function acquirer 120 may use the following Equation (1) to acquire the middle open loop transfer function G_{O1′} corresponding to the original system closed loop data B1, where G_{C1′} in the Equation (1) is a close loop transfer function of the original system closed loop data B1 (i.e., the close loop transfer function of the control system).

$${G}_{O {1}^{′}} = \frac{{G}_{C {1}^{′}}}{1 - {G}_{C {1}^{′}}} \qquad ( 1 )$$

In the step S122, the open loop transfer function acquirer 120 judges whether a phase of the middle open loop transfer function G_{O1′} and a phase of a Bode plot are continuous or not. When the phase of the phase Bode plot of the middle open loop transfer function G_{O1′} is continuous, the process enters the step S123. When the phase of the phase Bode plot of the middle open loop transfer function G_{O1′} is discontinuous, the original system closed loop data B1 is re-computed. For example, when the phase is discontinuous, it represents that the phase calculation may have errors, so the phase may be corrected (the addition or subtraction of 360 degrees) to acquire the correct and continuous phase data. Then, the process returns to the step S121, and the process enters the step S123 until the phase of the phase Bode plot of the middle open loop transfer function G_{O1′} is continuous.

In the step S123, because the phase of the phase Bode plot of the middle open loop transfer function G_{O1′} is continuous, the open loop transfer function acquirer 120 takes the middle open loop transfer function G_{O1′} as the original system open loop transfer function G_{O1}.

In a step S130, the speed optimizer 130 performs the speed optimization on the original system open loop transfer function G_{O1′}. There are many speed optimization procedures in the step S130, and one of the steps S131 to S136 is described in the following.

In the step S131, the speed optimizer 130 sets a value of the middle speed parameter V_{G′}.

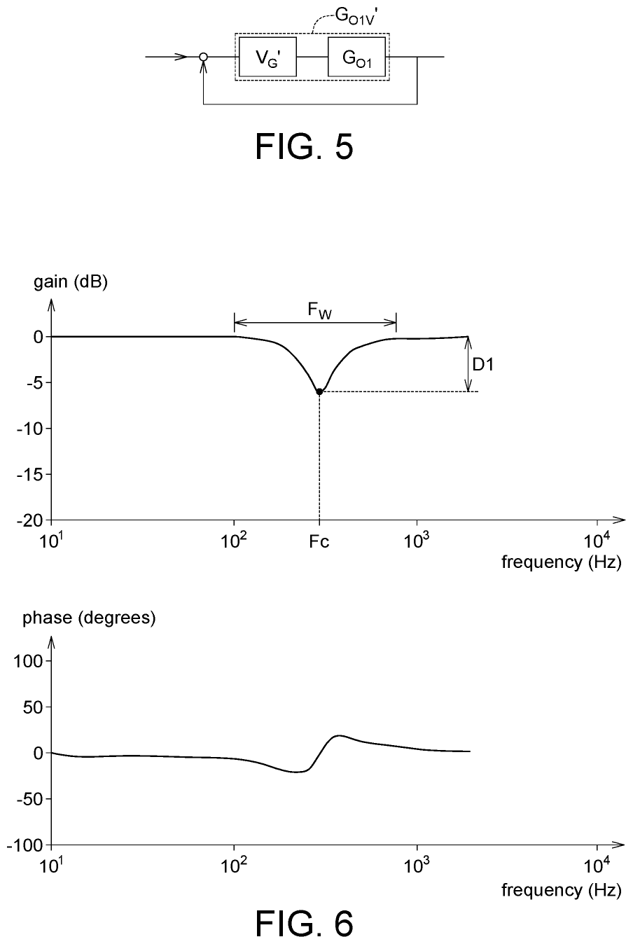

FIG. 5 is a block diagram showing a control system constituted by a middle speed optimized open loop transfer function G_{O1V′} according to the embodiment of this disclosure. In the step S132, as shown in FIG. 5, the speed optimizer 130 may use the following Equations (2a) to (2c) to acquire an open loop transfer function of the control system (the control system shown in FIG. 5) constituted by the original system open loop transfer function G_{O1} and the middle speed parameter V_{G′}, that is, the open loop transfer function of the control system refers to the middle speed optimized open loop transfer function G_{O1V′}. Specifically speaking, the speed optimizer 130 may use the following Equation (2a) to convert the original system open loop transfer function G_{O1} into the form represented by a gain M₀ and a phase θ, where the gain M_{O} and the phase θ may be represented in a complex space (not shown) having the x-axis as the real axis and the y-axis as the imaginary axis. The speed optimizer 130 may use the following Equation (2b) to multiply the original system open loop transfer function G_{O1} by the middle speed parameter V_{G1′} to acquire the middle speed optimized open loop transfer function G_{OV′}. The speed optimizer 130 may use the following Equation (2c), where the Equation (2a) is substituted into the Equation (2b) and the middle speed optimized open loop transfer function G_{O1V′} of the Equation (2b) is converted into the form represented by a gain M_{0′} and phase θ′, where the gain M_{0′} and the phase θ′ may be represented in the complex space having the x-axis as the real axis and the y-axis as the imaginary axis. Unless the value of the middle speed parameter V_{G1′} is equal to 1, the gain M_{0′} of the middle speed optimized open loop transfer function G_{GO1V′} is different from the gain M₀ of the original system open loop transfer function G_{O1}. Because the middle speed parameter V_{G1′} is an integer, the phases are not changed, that is, the phases θ′ and θ are the same (i.e., θ=θ′).

G_{O1}=M₀×cos(θ)+i(M₀×sin(θ)) (2a)

G_{O1V′}=G_{O1}×V_{G′} (2b)

G_{O1V′}=M_{0′}×cos(θ′)+i(M_{0′}×sin(θ′)) (2c)

In the step S133, the speed optimizer 130 may use the following Equations (3a) to (3b) to acquire a middle speed optimized close loop transfer function G_{C1V′} corresponding to the middle speed optimized open loop transfer function G_{O1V′} (as shown in FIG. 5). For example, the speed optimizer 130 uses the following Equation (3a) to convert the middle speed optimized open loop transfer function G_{O1V′} into the middle speed optimized close loop transfer function G_{C1V′}. As shown in the Equation (3b), the speed optimizer 130 converts the middle speed optimized close loop transfer function G_{C1V′} to the form represented by a gain M_{C′} and a phase θ_{C′}, where the gain M_{C′} and the phase θ_{C′} may be represented in the complex space (not shown) having the x-axis as the real axis and the y-axis as the imaginary axis (i.e., θ_{C′}≠θ′).

$$\begin{matrix}{G}_{C 1 {V}^{′}} = \frac{{G}_{O 1 {V}^{′}}}{1 + {G}_{O 1 {V}^{′}}} & ( 3 a ) \\ {G}_{C 1 {V}^{′}} = {M}_{{C}^{′ }} \times cos ( {θ}_{C}^{′} ) + i ( {M}_{{C}^{′}} \times sin ( {θ}_{C}^{′} ) ) & ( 3 b )\end{matrix}$$

In the step S134, the speed optimizer 130 judges whether the gain M_{C′} of the middle speed optimized close loop transfer function G_{C1V′} falls within an allowable range or not. When the gain M_{C′} falls within the allowable range, the process enters the step S135. When the gain M_{C′} falls outside the allowable range, the process enters the step S136, the middle speed parameters V_{G′} having different values are reset, and then the steps S132 to S134 are repeated until the gain M_{C′} falls within the allowable range. In addition, the allowable range may be, for example, the gain margin (when the phase is equal to −180 degrees) shall be higher than or equal to 10 dB. That is, the gain value corresponding to the phase Bode plot at −180 degrees is smaller than −10 dB, for example.

In the step S135, because the gain M_{C′} of the middle speed optimized close loop transfer function G_{C1V′} falls within the allowable range, the speed optimizer 130 takes the middle speed parameter V_{G′} as the optimized speed parameter V_{G}, and takes the middle speed optimized close loop transfer function G_{C1V′} as the speed optimized close loop transfer function G_{C1V}. The subsequent step may perform the filter optimization procedure according to the speed optimized close loop transfer function G_{C1V}.

As shown in FIG. 3, compared with the frequency-versus-gain relationship curve C1 before the speed optimization, the system bandwidth of the frequency-versus-gain relationship curve C1′ after the speed optimization is significantly increased (can be seen from the gain increase). The curve C1′ has resonance points, such as the resonance points P1 and P2 respectively corresponding to the frequencies f1 and f2. Nevertheless, the gain of the resonance point may be reduced through the following filter optimization procedure. That is, the influence of the resonance is improved. One resonance point may use a filter to reduce its gain. In this embodiment, because there are two resonance points, two filters, such as a first filter F1 and a second filter F2, may be used.

In a step S140, the speed optimizer 130 may adopt the the converted equation similar to the above-mentioned Equation (1), which converts the close loop transfer function into the open loop transfer function. The speed optimizer 130 then acquires the speed optimized open loop transfer function G_{O1V} corresponding to the speed optimized close loop transfer function G_{C1V}, and the speed optimized open loop transfer function G_{O1V} participates in the subsequent filter optimization procedure. The filter optimization shall be mainly based on the open loop transfer function (i.e., the speed optimized open loop transfer function G_{O1V}), and the speed optimized open loop transfer function G_{O1V} is converted from the speed optimized close loop transfer function G_{C1V}. In other words, the close loop needs to be converted into the open loop, so that the filter optimization can be performed.

In a step S150, the filter optimizer 140 determines initial parameters of a filter transfer function of a filter, such as an initial parameter of a first filter transfer function H1_{F}(s) of the first filter F1 and an initial parameter of a second filter transfer function H2_{F}(s) of the second filter F2. The initial parameters are, for example, a center frequency, a bandwidth and a damping ratio of the filter transfer function.

There are many methods to finish determining the initial parameters of the filter transfer function in the step S150, and one of steps S151 to S156 is described in the following.

In the step S151, the filter optimizer 140 sets an adjustment target of the filter. The adjustment target of the filter is, for example, the gain adjustment target for the resonance points P1 and P2 of the frequency-versus-gain relationship curve C1′, such as the rate of decrease of the gain on the resonance points P1 and P2.

FIG. 6 is a Bode plot showing the first filter transfer function H1_{F}(s) of the first filter F1 according to an embodiment of this disclosure. In the step S152, as shown in FIG. 6, a Bode plot of the second filter transfer function H2_{F}(s) may be similar to that of the first filter transfer function H1_{F}(s). In this step, the filter optimizer 140 sets the center frequency of the filter. For example, the center frequency F_{c} of the first filter transfer function H1_{F}(s) is set as a frequency f1, and the center frequency F_{c}(not shown) of the second filter transfer function H2_{F}(s) is set as a frequency f2. As shown in FIG. 6, the frequency corresponding to the lowest point of the depression region of the first filter transfer function H1_{F}(s) is the center frequency F_{c}.

In the step S153, the filter optimizer 140 sets a bandwidth F_{w} and a damping ratio F_{d} of each filter. As shown in FIG. 6, the bandwidth F_{w} of the first filter transfer function H1_{F}(s) may be determined according to the bandwidth range of the resonance point P1 to be improved. For example, when the bandwidth range of the resonance point P1 in FIG. 3 to be improved is wider, the bandwidth F_{w} of the first filter transfer function H1_{F}(s) in FIG. 6 may be designed to be wider. The damping ratio F_{d} of the first filter transfer function H1_{F}(s) may be determined according to the gain amplitude of the resonance point P1 to be reduced. For example, when the gain amplitude of the resonance point P1 in FIG. 3 to be reduced is larger, a depressed depth D1 of the first filter transfer function H1_{F}(s) in FIG. 6 may be designed to be deeper. The designs of the bandwidth F_{w} and the damping ratio F_{d} of the second filter transfer function H2_{F}(s) are similar to or the same as those of the bandwidth F_{w} and the damping ratio F_{d} of the first filter transfer function H1_{F}(s), and detailed descriptions thereof will be omitted here.

In addition, in this step, the first filter transfer function H1_{F}(s) of the first filter F1 and its center frequency F_{c}, bandwidth F_{w} and damping ratio F_{d} can be expressed by the following Equations (4a) to (4d), the second filter transfer function H2_{F}(s) of the second filter F2 and its center frequency F_{c}, bandwidth F_{w} and damping ratio F_{d} can be expressed by equations similar to the following Equations (4a) to (4d), and detailed descriptions thereof will be omitted here. The center frequency F_{c}, the bandwidth F_{w} and the damping ratio F_{d} are set according to the resonance point P1, and are respectively substituted into the flowing equations to determine coefficients a, b and ω_{C} of the first filter transfer function H1_{F}(s).

$$\begin{matrix}{ω}_{C} = 2 π \times {F}_{C} & ( 4 a ) \\ b = 2 \times {ω}_{C} \times ( {F}_{w} / {F}_{C} ) & ( 4 b ) \\ a = b \times ( \frac{{F}_{d}}{100} ) & ( 4 c ) \\ H {1}_{F} ( s ) = \frac{{s}^{2} + a \times s + {ω}_{C}^{2}}{{s}^{2} + b \times s + {ω}_{C}^{2}} & ( 4 d )\end{matrix}$$

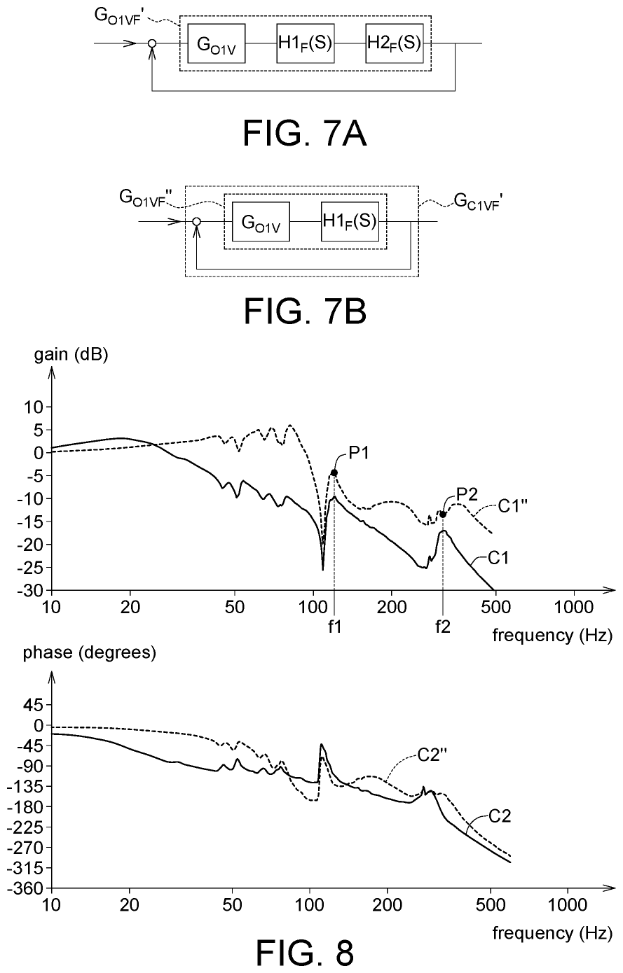

In the step S154, a first filter optimized open loop transfer function G_{O1VF′} of a control system constituted by the speed optimized open loop transfer function G_{O1V}, the first filter transfer function H1_{F}(s) and the second filter transfer function H2_{F}(s) is acquired, as shown in FIG. 7A. FIG. 7A is a block diagram showing the control system constituted by the speed optimized open loop transfer function G_{O1V′} the first filter transfer function H1_{F}(s) and the second filter transfer function H2_{F}(s) according to an embodiment of this disclosure. The first filter optimized open loop transfer function G_{O1VF′} is the open loop transfer function of the control system in FIG. 7A.

In the step S155, the filter optimizer 140 judges whether the first filter optimized open loop transfer function G_{O1VF′} satisfies the adjustment target of the filter or not. For example, the filter optimizer 140 judges whether the first filter optimized open loop transfer function G_{O1VF′} decreases the gains of the first resonance point P1 and the second resonance point P2 to the stable range or not, wherein the stable range depends on the phase of the frequency. For example, when the phase is equal to −135 degrees, the gain value is smaller than −3 dB; and when the phase is −180 degrees, the gain value is smaller than −10 dB. If yes, the center frequencies F_{c}, the bandwidths F_{w} and the damping ratios F_{d} set by the current first filter transfer function H1_{F}(s) and second filter transfer function H2_{F}(s) serve as the initial parameters of the filter transfer function. If not, the process returns to the step S153 to reset the bandwidth F_{w} and the damping ratio F_{d} having different values, and then the steps S154 to S155 are repeated until whether the first filter optimized open loop transfer function G_{O1VF′} satisfies the adjustment target of the filter or not.

In addition, the process of the steps S151 to 155 may be performed on one filter transfer function. After the initial parameters of the filter transfer function are determined, the next filter transfer function is accumulated until the initial parameters of all filter transfer functions are completely determined.

In the step S156, the filter optimizer 140 screens the number of the filters to satisfy the actual condition of the machine tool 10. For example, when the controller (not shown) of the machine tool 10 only accepts the addition of A1 filters (A1 refers to numbers of filters), the number of the filters determined by the filter optimizer 140 is A2. When A1 is greater than or equal to A2, it represents that all the filters determined by the filter optimizer 140 may participate in the system optimization. If A1 is smaller than A2, then the filter optimizer 140 selects the filters according to the order of the resonance frequencies from low to high. For example, if the controller of the machine tool 10 only allows one filter to participate in the optimization, then the filter optimizer 140 preferably selects a filter F1 corresponding to the resonance point P1 (the frequency is lower). In the described example of the embodiment of this disclosure, all filters F (e.g., two filters) are selected, but the embodiments of this disclosure are not limited thereto.

Then, in a step S160, the filter optimizer 140 executes a filter optimization procedure. In the filter optimization procedure, the filter optimizer 140 performs an overall operation on the selected filter transfer function and speed optimized open loop transfer function G_{O1V} to optimize the parameter of the filter (hereinafter, the optimized parameter is referred to as the “optimized filter parameter”).

There are many methods of finishing the filter optimization procedure of the step S160, and one of steps S161 to S169 is described in the following.

FIG. 7B is a block diagram showing a control system constituted by the first filter transfer function H1_{F}(s) and the speed optimized open loop transfer function G_{O1V} according to an embodiment of this disclosure. Referring to FIG. 7B, in the step S161, the filter optimizer 140 acquires the filter optimized close loop transfer function G_{C1VF′} of the control system (i.e., the system block diagram in FIG. 7B) constituted by N of the selected filter transfer functions and the speed optimized open loop transfer function G_{O1V}, where the initial value of N is 1 (N refers to a number). When N is equal to 1, only one (N is equal to 1) filter transfer function, such as the first filter transfer function H1_{F}(s), is added to the filter optimization procedure. In other words, the filter optimizer 140 acquires the filter optimized close loop transfer function G_{C1VF′} of the control system (i.e., the system block diagram in FIG. 7B) constituted by the first filter transfer function H1_{F}(s) and the speed optimized open loop transfer function G_{O1V}.

In the step S162, the filter optimizer 140 determines whether the filter optimized close loop transfer function G_{C1VF′} satisfies a close loop adjustment condition or not. When the filter optimized close loop transfer function G_{C1VF′} satisfies the close loop adjustment condition, the process enters the step S163. The close loop adjustment condition includes, for example, that a gain margin (GM) is equal to or greater than 4 dB, and a phase margin (PM) is equal to or greater than +/−45 degrees. When the filter optimized close loop transfer function G_{C1VF′} does not satisfy the close loop adjustment condition, the process enters the step S164 to re-adjust the damping ratio F_{d} and the bandwidth F_{w} of the first filter transfer function H1_{F}(s), and then the flow returns to the step S161.

In the step S163, the filter optimizer 140 acquires the second filter optimized open loop transfer function G_{O1VF″} of a control system (i.e., the system block diagram in FIG. 7B) constituted by N of the selected filter transfer functions and the speed optimized open loop transfer function G_{O1V}.

In the step S165, the filter optimizer 140 judges whether the second filter optimized open loop transfer function G_{O1VF″} satisfies an open loop adjustment condition or not. The open loop adjustment condition includes, for example, that the gain margin is equal to or greater than 4 dB, and the phase margin is equal to or greater than +/−45 degrees. When the second filter optimized open loop transfer function G_{O1VF″} satisfies the open loop adjustment condition, the process enters the step S166. When the second filter optimized open loop transfer function G_{O1VF″} does not satisfy the open loop adjustment condition, the process enters the step S167 to re-adjust the damping ratio F_{d} and the bandwidth F_{w} of the first filter transfer function H1_{F}(s), and then the flow returns to the step S163 or S161.

In the step S166, the filter optimizer 140 judges whether N is equal to the number A2 or not, wherein the number A2 is the number of the filters (or the filter transfer functions). If N is smaller than the number A2, then it represents that there is still a filter transfer function not added to the filter optimization procedure, and thus the process enters the step S169; if N is equal to A2, then it represents that all filter transfer functions (or the filters) have been added to the filter optimization procedure, and thus the process enters the step S168.

In the step S169, the filter optimizer 140 accumulates a value of N (e.g., N=N+1 is set), and the two (N is equal to 2 after accumulation in this example) filter transfer functions (i.e., the first filter transfer function H1_{F}(s) and the second filter transfer function H2_{F}(s)) are added to the filter optimization procedure (i.e., the second filter transfer function H2_{F}(s) is added to the system block diagram in FIG. 7B, for example, as listed on the right side of the block H1_{F}(s) in FIG. 7B), and then the flow returns to the step S161. Based on this principle, the process stops until all filter transfer functions satisfy the open loop adjustment condition and the close loop adjustment condition in the filter optimization procedure.

In the step S168, when all filter transfer functions satisfy the open loop adjustment condition and the close loop adjustment condition in the filter optimization procedure, the filter optimizer 140 takes the filter transfer function satisfying the close loop adjustment condition and the open loop adjustment condition as the optimized filter transfer function, wherein the center frequency, the bandwidth and the damping ratio of optimized filter transfer function are regarded as optimized filter parameters. At this point, the filter optimization procedure is finished.

FIG. 8 is a system Bode plot acquired after speed optimization and filter optimization according to an embodiment of this disclosure. In the gain Bode plot, the curve C1 is a frequency-versus-gain relationship curve before the speed optimization and the filter optimization, and the curve C1″ is a frequency-versus-gain relationship curve after the speed optimization and the filter optimization. In the phase Bode plot, the curve C2 is a frequency-versus-phase relationship curve before the speed optimization and the filter optimization, and the curve C2″ is a frequency-versus-phase relationship curve after the speed optimization and the filter optimization. Comparing the curve C1′ of FIG. 3 with the curve C1″ of FIG. 8, it is obtained that the gain of the resonance points P1 and P2 and its peripheral bandwidth at the curve C1″ is significantly decreased than these at the curve C1′ after the speed optimization and the filter optimization.

In summary, in the method for adjusting the frequency response parameter of the machine tool of the embodiment of this disclosure, only one actual machine frequency sweeping is performed on the machine tool, all the next procedures (e.g., the speed optimization procedure and the filter optimization procedure) are achieved by way of computer numerical calculation using the original system closed loop data B1, and no data needs to be obtained from the machine tool 10 until the speed optimization and the filter optimization are completed. Consequently, the method for adjusting the frequency response parameter of the machine tool of the embodiment of this disclosure can quickly and correctly complete the performance adjustment of the machine, and this is beneficial to product shipment and increases the product lifetime.

After the speed optimization procedure and the filter optimization procedure are finished, the adjustment system 100 outputs the finally obtained optimized speed parameter V_{G} and the filter optimization parameter of each filter transfer function. Then, the optimized speed parameter V_{G} and the optimized filter parameter of each filter transfer function are again inputted to the controller (not shown) of the machine tool 10 to improve or increase the performance of the machine tool 10.

In summary, in the method and the system for adjusting the frequency response parameter of the machine tool of the embodiments of this disclosure, only one actual machine frequency sweeping is performed on the machine, and the next optimization procedures are achieved by way of computer numerical calculation. So, the embodiments of this disclosure have at least the following advantages: (1) the computer operation speed is fast, and the shipment adjustment time of the product is shortened; (2) the computer operation speed is fast, so the individual operations can be performed on all the machine tools 10, rather than the conventional adjustment method, in which the parameters of one machine tool is applied to all the machine tool; (3) the machine can be kept at the excellent performance (e.g., the high precision and the high stability) for a long time through the optimization procedure; (4) the computer operation provides standardized optimization processes; and (5) the conventional drawback of the difficulty of training the adjustment staffs, and the personnel cost can be significantly reduced.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for adjusting a frequency response parameter of a machine tool, comprising steps of:
performing an actual frequency sweep on the machine tool to acquire an original system closed loop data of the machine tool;
acquiring an original system open loop transfer function of the original system closed loop data;
executing a speed optimization procedure to acquire a speed optimized close loop transfer function and an optimized speed parameter;
acquiring a speed optimized open loop transfer function corresponding to the speed optimized close loop transfer function;
determining a filter transfer function of a filter; and
executing a filter optimization procedure to acquire an optimized filter transfer function.

2. The method according to claim 1, wherein the speed optimization procedure comprises:
acquiring a middle speed optimized open loop transfer function of a control system constituted by the original system open loop transfer function and a middle speed parameter;
acquiring a middle speed optimized close loop transfer function corresponding to the middle speed optimized open loop transfer function;
judging whether a gain of the middle speed optimized close loop transfer function falls within an allowable range or not; and
taking the middle speed optimized close loop transfer function as the speed optimized close loop transfer function and taking the middle speed parameter as the optimized speed parameter when the gain of the middle speed optimized close loop transfer function falls within the allowable range.

3. The method according to claim 1, wherein the filter optimization procedure comprises:
acquiring a filter optimized close loop transfer function of a control system constituted by the filter transfer function and the speed optimized open loop transfer function;
judging whether the filter optimized close loop transfer function satisfies a close loop adjustment condition or not;
acquiring a filter optimized open loop transfer function of the control system constituted by the filter transfer function and the speed optimized open loop transfer function;
judging whether the filter optimized open loop transfer function satisfies an open loop adjustment condition or not; and
taking the filter transfer function satisfying the close loop adjustment condition and the open loop adjustment condition as the optimized filter transfer function when the filter optimized close loop transfer function satisfies the close loop adjustment condition and the filter optimized open loop transfer function satisfies the open loop adjustment condition.

4. The method according to claim 1, wherein the original system closed loop data comprises a gain Bode plot and a phase Bode plot.

5. The method according to claim 1, wherein the step of acquiring the original system open loop transfer function, the step of executing the speed optimization procedure, the step acquiring the speed optimized open loop transfer function, the step of determining the filter transfer function and the step of executing the filter optimization procedure are achieved by way of computer numerical calculation.

6. The method according to claim 1, wherein the step of acquiring the original system open loop transfer function of the original system closed loop data comprises:
acquiring a middle open loop transfer function corresponding to the original system closed loop data;
judging whether a phase of the middle open loop transfer function is continuous or not; and
taking the middle open loop transfer function as the original system open loop transfer function when the phase of the middle open loop transfer function is continuous.

7. The method according to claim 2, wherein the step of executing the speed optimization procedure further comprises:
setting a value of the middle speed parameter; and
resetting the value of the middle speed parameter and returning to the step of acquiring the middle speed optimized open loop transfer function when the gain of the middle speed optimized close loop transfer function falls outside the allowable range.

8. The method according to claim 3, wherein the step of executing the filter optimization procedure further comprises:
re-adjusting parameters of the filter transfer function, and then returning to the step of acquiring the filter optimized close loop transfer function when the filter optimized close loop transfer function does not satisfy the close loop adjustment condition.

9. The method according to claim 3, wherein the step acquiring the speed optimized open loop transfer function comprises: determining the filter transfer function of each of a plurality of filters;
wherein the filter optimization procedure further comprises: setting an initial value of N as 1;
the step of acquiring the filter optimized close loop transfer function further comprises: acquiring the filter optimized close loop transfer function of the control system constituted by N of the filter transfer functions and the speed optimized open loop transfer function;
the step of acquiring the filter optimized open loop transfer function further comprises: acquiring the filter optimized open loop transfer function of the control system constituted by N of the filter transfer functions and the speed optimized open loop transfer function;
the filter optimization procedure further comprises, after the step of taking the filter transfer function satisfying the close loop adjustment condition and the open loop adjustment condition as the optimized filter transfer function:
accumulating a value of N, and returning to the step of acquiring the filter optimized close loop transfer function.

10. A system for adjusting a frequency response parameter of a machine tool, the system comprising:
a frequency sweeper performing an actual frequency sweep on the machine tool to acquire an original system closed loop data of the machine tool;
an open loop transfer function acquirer acquiring an original system open loop transfer function of the original system closed loop data;
a speed optimizer executing a speed optimization procedure to acquire a speed optimized close loop transfer function and an optimized speed parameter, wherein the speed optimization procedure comprises: acquiring a speed optimized open loop transfer function corresponding to the speed optimized close loop transfer function; and
a filter optimizer determining a filter transfer function of a filter and executing a filter optimization procedure to acquire an optimized filter transfer function.

11. The system according to claim 10, wherein in the speed optimization procedure, the speed optimizer:
acquires a middle speed optimized open loop transfer function of a control system constituted by the original system open loop transfer function and a middle speed parameter;
acquires a middle speed optimized close loop transfer function corresponding to the middle speed optimized open loop transfer function; judges whether a gain of the middle speed optimized close loop transfer function falls within an allowable range or not; and
takes the middle speed optimized close loop transfer function as the speed optimized close loop transfer function and takes the middle speed parameter as the optimized speed parameter when the gain of the middle speed optimized close loop transfer function falls within the allowable range.

12. The system according to claim 10, wherein in the filter optimization procedure, the filter optimizer further:
acquires a filter optimized close loop transfer function of a control system constituted by the filter transfer function and the speed optimized open loop transfer function;
judges whether the filter optimized close loop transfer function satisfies a close loop adjustment condition or not;
acquires a filter optimized open loop transfer function of the control system constituted by the filter transfer function and the speed optimized open loop transfer function;
judges whether the filter optimized open loop transfer function satisfies an open loop adjustment condition or not; and
takes the filter transfer function satisfying the close loop adjustment condition and the open loop adjustment condition as the optimized filter transfer function when the filter optimized close loop transfer function satisfies the close loop adjustment condition and the filter optimized open loop transfer function satisfies the open loop adjustment condition.

13. The system according to claim 10, wherein the original system closed loop data comprises a gain Bode plot and a phase Bode plot.

14. The system according to claim 10, wherein steps of acquiring the original system open loop transfer function, executing the speed optimization procedure, acquiring the speed optimized open loop transfer function, determining the filter transfer function and executing the filter optimization procedure are achieved by way of computer numerical calculation.

15. The system according to claim 10, wherein in the step of acquiring the original system open loop transfer function of the original system closed loop data, the open loop transfer function acquirer further:
acquires a middle open loop transfer function corresponding to the original system closed loop data;
judges whether a phase of the middle open loop transfer function is continuous or not; and
takes the middle open loop transfer function as the original system open loop transfer function when the phase of the middle open loop transfer function is continuous.

16. The system according to claim 11, wherein in the step of executing the speed optimization procedure, the speed optimizer further:
sets a value of the middle speed parameter; and
resets the value of the middle speed parameter and returns to the step of acquiring the middle speed optimized open loop transfer function when the gain of the middle speed optimized close loop transfer function falls outside the allowable range.

17. The system according to claim 12, wherein in the filter optimization procedure, the filter optimizer further:
re-adjusts parameters of the filter transfer function when the filter optimized close loop transfer function does not satisfy the close loop adjustment condition, and re-acquires the filter optimized open loop transfer function of the control system constituted by the filter transfer function and the speed optimized open loop transfer function.

18. The system according to claim 12, wherein in the step of acquiring the speed optimized open loop transfer function, the filter optimizer further determines the filter transfer function of each of a plurality of filters;
wherein in the filter optimization procedure, the filter optimizer further sets an initial value of N as 1;
in the step of acquiring the filter optimized close loop transfer function, the filter optimizer further acquires the filter optimized close loop transfer function of the control system constituted by N of the filter transfer functions and the speed optimized open loop transfer function;
in the step of acquiring the filter optimized open loop transfer function, the filter optimizer further acquires the filter optimized open loop transfer function of the control system constituted by N of the filter transfer functions and the speed optimized open loop transfer function;
after the step of taking the filter transfer function satisfying the close loop adjustment condition and the open loop adjustment condition as the optimized filter transfer function, the filter optimizer further:
accumulates a value of N, and returns to the step of acquiring the filter optimized close loop transfer function of the control system constituted by the filter transfer function and the speed optimized open loop transfer function.
